(19) United States
(12) Patent Application Publication
(10) Pub. No.: US 2026/0087542 A1
(43) Pub. Date: Mar. 26, 2026

(54) Electronic Devices, Methods, and Corresponding Systems for Precluding User Interaction Events in an Interactive Computing Environment

(71) Applicant: Motorola Mobility LLC, Chicago, IL (US)

(72) Inventors: Krishnan Raghavan, Bangalore (IN); Vijayprakash Idlur, Bangalore (IN); Prasad A G, Nagpur (IN)

(21) Appl. No.: 18/891,723

(22) Filed: Sep. 20, 2024

(51) Int. Cl. G06Q 30/0601; G06Q 30/01

(52) U.S. Cl. CPC G06Q 30/0637; G06Q 30/01; G06Q 30/0641

(57) ABSTRACT

An electronic device includes one or more processors, a user interface, and a memory. The device operates an electronic shopping interactive computing environment. Upon initiation of an interactive session, the processors determine a fraudulent return propensity score based on various input parameters, including device-level activities such as subscriber identification module card swaps, factory resets, and application reinstalls. When the propensity score exceeds a predefined threshold, the processors preclude one or more user interaction events, such as shopping cart interactions or product returns, from occurring in the shopping environment. The system can employ a machine learning algorithm to generate a normalized propensity score, enhancing fraud detection accuracy. This proactive approach mitigates the risk of fraudulent returns, protecting retailers from financial losses and maintaining the integrity of the e-commerce platform.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. When used in conjunction with e-commerce sites, such devices make it incredibly simple to purchase goods and services with just a click or two.

At the same time, fraudulent returns remain a significant problem in e-commerce, with dishonest customers exploiting return policies to return used or mismatched items for refunds or exchanges, resulting in financial losses for retailers. It would be advantageous to have improved electronic devices, methods, and corresponding systems that alleviate this problem.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system and method in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory system in accordance with one or more embodiments of the disclosure.

FIG. 5 illustrates one explanatory electronic device in accordance with one or more embodiments of the disclosure.

FIG. 6 illustrates one explanatory electronic device in accordance with one or more embodiments of the disclosure.

FIG. 7 illustrates one explanatory electronic device in accordance with one or more embodiments of the disclosure.

FIG. 8 illustrates one explanatory system in accordance with one or more embodiments of the disclosure.

FIG. 9 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to, in response to initiation of an interactive session in an electronic shopping interactive computing environment operating on one or more processors of the electronic device, determining, by the one or more processors, a fraudulent return propensity score and, when the fraudulent return propensity score exceeds a predefined threshold, precluding one or more user interaction events from occurring in the electronic shopping interactive computing environment. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations.

It will be appreciated that embodiments of the disclosure described herein may be comprised of one or more conventional processors and unique stored program instructions that control the one or more processors to implement, in conjunction with certain non-processor circuits, some, most, or all of the functions of, in response to one or more processors of an electronic device detecting commencement of an interactive shopping session in an electronic shopping application operating on the one or more processors, determining a fraudulent return propensity score and when the fraudulent return propensity score exceeds a predefined threshold, precluding one or both of shopping cart user interaction events and/or product return user interaction events from occurring in the electronic shopping application, as described herein. The non-processor circuits may include, but are not limited to, a radio receiver, a radio transmitter, signal drivers, clock circuits, power source circuits, and user input devices. As such, these functions may be interpreted as steps of a method to perform determining, by one or more processors, a normalized fraudulent return propensity score from the plurality of input parameters, retrieving, by the one or more processors from a memory, the normalized fraudulent return propensity score in response to initiation of an interactive session of an electronic shopping interactive computing environment operating on the one or more processors of the electronic device, and presenting, by the one or more processors on a user interface in response to the normalized fraudulent return propensity score exceeding a predefined threshold, a prompt.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, fraudulent returns remain a significant problem in e-commerce, with dishonest customers exploiting return policies to return used or mismatched items for refunds or exchanges, resulting in financial losses for retailers. E-commerce retailers implement preventive measures such as tracking return patterns and identifying suspicious behavior. They employ sophisticated fraud detection tools to spot irregularities in return requests. Customer identity verification, restocking fees, and limiting return windows are common strategies. Clear return policies and terms, along with thorough inspection of returned items, help deter fraudulent activity. Collaborating with third-party fraud prevention services further enhances security.

E-commerce retailers face a significant challenge in detecting fraud due to limitations in their ability to conduct advanced analysis of user behavior. Embodiments of the disclosure contemplate that while device Internet Protocol (IP) addresses provide some information, certain user actions can be telltale signs of potential fraud, such as frequently resetting their devices, uninstalling and reinstalling applications multiple times, or frequently changing identity modules. Embodiments of the disclosure further contemplate that these behaviors obscure a consistent user identity.

Embodiments of the disclosure further contemplate that many e-commerce platforms lack comprehensive data on these actions occurring outside their applications and websites. They often do not have access to device-level data, making tracking behaviors like resets, application reinstallations, or identity module changes difficult. This limitation hampers their ability to proactively identify and flag potential fraudulent accounts accurately.

Advantageously, embodiments of the disclosure provide a solution to these and other problems. In one or more embodiments, a method in an electronic device comprises, in response to initiation of an interactive session in an electronic shopping interactive computing environment operating on one or more processors of the electronic device, determining, by the one or more processors, a fraudulent return propensity score. In one or more embodiments, when the fraudulent return propensity score exceeds a predefined threshold, the method comprises precluding one or more user interaction events from occurring in the electronic shopping interactive computing environment

By determining a fraudulent return propensity score in response to the initiation of an interactive session in an electronic shopping interactive computing environment, embodiments of the disclosure can proactively identify users with a high likelihood of committing fraudulent returns. This allows for real-time decision-making to preclude user interaction events, thereby preventing potential fraud before it occurs. This proactive approach enhances the security and integrity of the e-commerce platform, reducing financial losses for retailers.

The integration of device-level data, such as subscriber identity module (SIM) card swaps, factory resets, and application reinstallations, provides a more comprehensive analysis of user behavior compared to traditional methods that rely solely on application-level data. This deeper insight into user actions enables more accurate identification of suspicious behavior patterns, which are indicative of potential fraud.

Precluding user interaction events when the fraudulent return propensity score exceeds a predefined threshold ensures that users identified as high-risk are restricted from performing actions that could lead to fraudulent returns. This not only protects the retailer from financial losses but also maintains a fair shopping environment for honest customers.

For example, if a user frequently resets their device and changes SIM cards, these actions are recorded and factored into the propensity score. If the score exceeds the threshold, the system can block the user from making new orders or returning products, thereby mitigating the risk of fraud. This method leverages device data to enhance fraud detection capabilities, which is a significant improvement over existing solutions that do not have access to such detailed user behavior data.

In one or more embodiments, a system records various device-level data parameters to identify potential fraudulent returners. These parameters include SIM card swaps, factory data resets (FDR), application data/cache clears, application logouts/logins, and application uninstalls/reinstalls. In one or more embodiments, the system also records user account information such as phone numbers, login identifiers, addresses, and payment information across these device-level activities. By tracking these parameters, the system can detect patterns indicative of fraudulent behavior.

Upon detecting at least one order return request within a predefined period, the system calculates a propensity score for the user based on the recorded data. This propensity score quantifies the likelihood of the user engaging in fraudulent returns. In one or more embodiments, the system employs a machine learning algorithm to weigh the various parameters and generate a normalized propensity score ranging from 0 to 1, where 1 indicates a high likelihood of fraud.

When the propensity score exceeds a predefined threshold, in one or more embodiments the system takes one or more preventive measures. These measures may include blocking the user from making new orders, alerting the user that no return facility is available for new orders, or blocking the device from accessing the online shopping application altogether. This proactive approach aims to mitigate the risk of fraudulent returns, thereby protecting retailers from financial losses and maintaining the integrity of the e-commerce platform.

Advantageously, the system provides a unique approach to preventing fraudulent product returns by leveraging device-level data to calculate a propensity score for each user. Unlike traditional fraud detection methods that primarily rely on application-level data and user behavior within the e-commerce platform, embodiments of the disclosure integrate additional data sources from the user's device. These data sources include SIM card swaps, factory data resets, application data/cache clears, application logouts/logins, and application uninstalls/reinstalls. By incorporating these device-level activities, the system can gain a more comprehensive understanding of user behavior, which is often indicative of potential fraud.

Furthermore, embodiments of the disclosure can utilize a machine learning algorithm to weigh these various parameters and generate a normalized propensity score ranging from 0 to 1, where 1 indicates a high likelihood of fraud. This score is used to make real-time decisions about precluding user interaction events, such as blocking new orders or returns, or even restricting access to the online shopping application. This proactive approach allows for immediate action to prevent fraudulent activities before they occur, enhancing the security and integrity of the e-commerce platform.

The integration of device-level data and the use of a propensity score for real-time fraud prevention are not found in existing solutions, making embodiments of the disclosure a novel and effective method for addressing the persistent issue of fraudulent product returns in e-commerce.

In one or more embodiments, an electronic device comprises a user interface, a memory, and one or more processors operable with the user interface and the memory. In response to the one or more processors detecting commencement of an interactive shopping session in an electronic shopping application operating on the one or more processors, in one or more embodiments the one or more processors determine a fraudulent return propensity score. When the fraudulent return propensity score exceeds a predefined threshold, the one or more processors preclude one or both of shopping cart user interaction events and/or product return user interaction events from occurring in the electronic shopping application in one or more embodiments.

By detecting the commencement of an interactive shopping session in an electronic shopping application, the one or more processors can determine a fraudulent return propensity score in real-time. This allows the system to proactively assess the risk of fraudulent behavior based on device-level data, such as SIM card swaps, factory resets, and application reinstallations, which are indicative of potential fraud.

When the fraudulent return propensity score exceeds a predefined threshold, the system precludes one or both of shopping cart user interaction events and/or product return user interaction events from occurring in the electronic shopping application. This ensures that users identified as high-risk are restricted from performing actions that could lead to fraudulent returns, thereby protecting the retailer from financial losses and maintaining a fair shopping environment for honest customers.

The integration of device-level data provides a more comprehensive analysis of user behavior compared to traditional methods that rely solely on application-level data. This deeper insight into user actions enables more accurate identification of suspicious behavior patterns, enhancing the security and integrity of the e-commerce platform.

For example, if a user frequently resets their device and changes SIM cards, these actions are recorded and factored into the propensity score. If the score exceeds the threshold, the system can block the user from making new orders or returning products, thereby mitigating the risk of fraud. This method leverages device data to enhance fraud detection capabilities, which is a significant improvement over existing solutions that do not have access to such detailed user behavior data.

As noted above, E-commerce retailers face a significant challenge in detecting fraud due to limitations in their ability to conduct advanced analysis of user behavior. To illustrate this fact, consider the following example.

In one scenario, a user named John exploits the return policies of online retailers to commit fraudulent returns. John orders high-end items such as mobile phones, cameras, and gaming consoles from various retailers. After using these items for a few days, John returns them for a refund.

When retailers catch on to his behavior and start refusing his returns, John adapts his tactics to avoid detection. He begins using different account logins, names, mobile SIM card numbers, payment methods, and addresses. Additionally, John frequently resets his phone, uninstalls and reinstalls the shopping application, and clears the application data to obscure his identity and continue his fraudulent activities.

Fraudsters like John employ various methods to exploit vulnerabilities in e-commerce systems. These methods include changing SIM cards, performing factory data resets, and repeatedly uninstalling and reinstalling shopping applications. By doing so, they create multiple identities and make tracking their fraudulent behavior difficult for retailers. This scenario highlights the need for robust security measures, fraud detection systems, user education, and proactive monitoring to mitigate the risks associated with such fraudulent activities.

To address this issue, the disclosed system records various device-level data parameters, such as SIM card swaps, factory default resets, application data/cache clears, application logouts/logins, and application uninstalls/reinstalls. By tracking these parameters, the system can detect patterns indicative of fraudulent behavior. The system calculates a propensity score for the user based on the recorded data, quantifying the likelihood of the user engaging in fraudulent returns. When the propensity score exceeds a predefined threshold, the system takes preventive measures, such as blocking the user from making new orders, alerting the user that no return facility is available for new orders, or blocking the device from accessing the online shopping application altogether. This proactive approach aims to mitigate the risk of fraudulent returns, thereby protecting retailers from financial losses and maintaining the integrity of the e-commerce platform.

In one or more embodiments, a method for an electronic device comprises monitoring, by one or more processors of the electronic device, a plurality of input parameters. The method further includes determining, by the one or more processors, a normalized fraudulent return propensity score from the plurality of input parameters. The method also involves retrieving, by the one or more processors from a memory, the normalized fraudulent return propensity score in response to initiation of an interactive session of an electronic shopping interactive computing environment operating on the one or more processors of the electronic device. Additionally, the method includes presenting, by the one or more processors on a user interface in response to the normalized fraudulent return propensity score exceeding a predefined threshold, a prompt.

The plurality of input parameters monitored by the one or more processors may include various device-level activities such as SIM card swaps, factory data resets, application data/cache clears, application logouts/logins, and application uninstalls/reinstalls. By tracking these parameters, the system can detect patterns indicative of fraudulent behavior. The normalized fraudulent return propensity score quantifies the likelihood of the user engaging in fraudulent returns, with a score ranging from 0 to 1, where 1 indicates a high likelihood of fraud.

When the normalized fraudulent return propensity score exceeds the predefined threshold, the one or more processors present a prompt on the user interface. This prompt may inform the user of restrictions on their ability to perform certain actions within the electronic shopping interactive computing environment, such as making new orders or returning products. This proactive approach aims to mitigate the risk of fraudulent returns, thereby protecting retailers from financial losses and maintaining the integrity of the e-commerce platform.

By monitoring a plurality of input parameters, the system can gather comprehensive data on user behavior, which is beneficial for accurately assessing the likelihood of fraudulent returns. This includes tracking device-level activities such as SIM card swaps, factory data resets, application data/cache clears, application logouts/logins, and application uninstalls/reinstalls. These parameters provide a deeper insight into user actions that are often indicative of potential fraud, enabling a more precise calculation of the fraudulent return propensity score.

Determining a normalized fraudulent return propensity score from the plurality of input parameters allows the system to quantify the risk of fraudulent behavior in a standardized manner. This score, which ranges from 0 to 1 in an illustrative embodiment, provides a clear metric for evaluating the likelihood of fraud, facilitating real-time decision-making to preclude user interaction events when necessary. This normalization process ensures that the score is consistent and comparable across different users and scenarios, enhancing the reliability of the fraud detection mechanism.

Retrieving the normalized fraudulent return propensity score in response to the initiation of an interactive session of an electronic shopping interactive computing environment ensures that the system can proactively assess the risk of fraud at the moment it is most relevant. This real-time retrieval allows the system to immediately evaluate the user's propensity for fraudulent returns as they engage with the shopping application, enabling timely preventive measures to be taken if the score exceeds a predefined threshold.

Presenting a prompt on the user interface in response to the normalized fraudulent return propensity score exceeding a predefined threshold serves as an immediate alert to the user about the restrictions on their ability to perform certain actions within the electronic shopping interactive computing environment. This prompt not only informs the user of the limitations but also acts as a deterrent against potentially fraudulent activities. By providing this real-time feedback, the system enhances transparency and helps maintain a fair shopping environment for all users.

Other advantages will be described below. Still others will be obvious to those of ordinary skill in the art having the benefit of this disclosure.

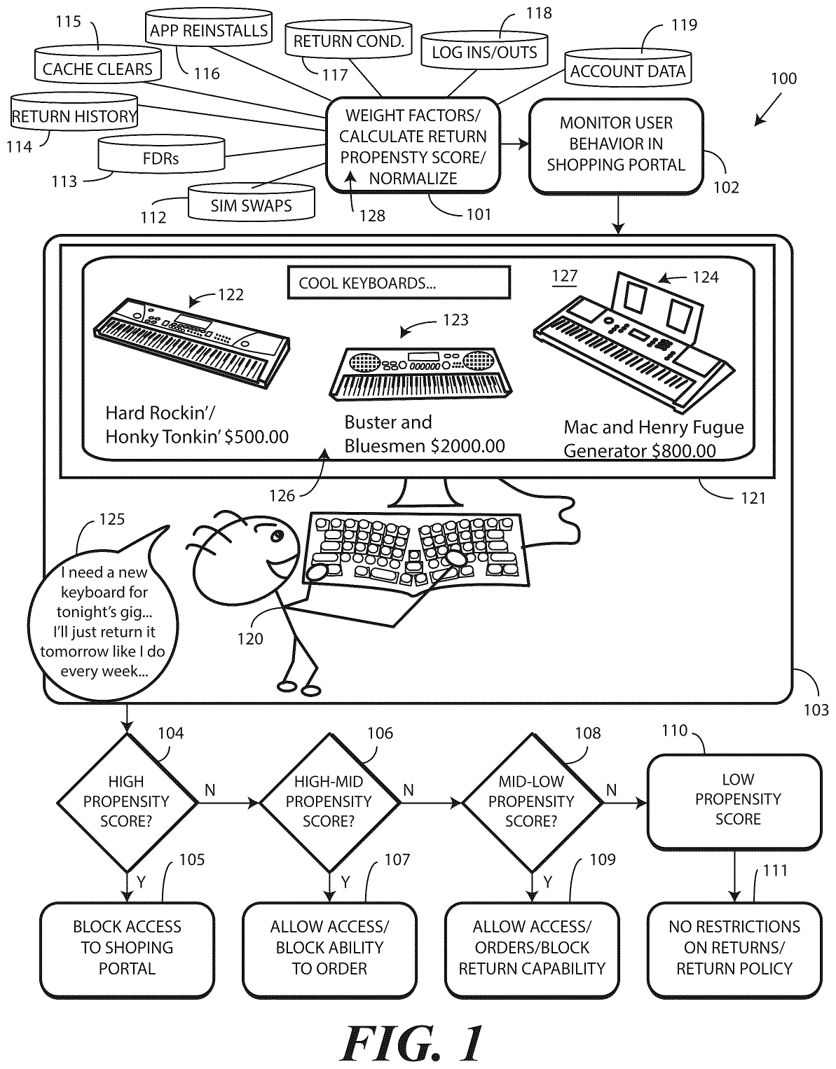

Turning now to FIG. 1, illustrated therein is one explanatory system 100 configured in accordance with one or more embodiments of the disclosure. The system 100 includes both electronic devices, one example of which is the computer shown at step 103, and various method steps for performing a method that, in response to initiation of an interactive session 126 in an electronic shopping interactive computing environment 127 operating on one or more processors of an electronic device 121, determines, by the one or more processors, a fraudulent return propensity score 128 at step 101. In one or more embodiments, when the fraudulent return propensity score 128 exceeds a predefined threshold, the method precludes one or more user interaction events from occurring, examples of which are shown at step 105, step 107, and step 109, in the electronic shopping interactive computing environment 127.

As shown at step 103, a shopper 120 notorious for making returns after using products, is in the market for a musical keyboard. Accordingly, the shopper 120 has initiated an electronic shopping interactive computing environment 127 to find just the right keyboard. Having just landed a wedding gig, the shopper 120 exclaims 125, “I need a new keyboard for tonight's gig . . . ”

In this illustration, initial options presented in response to the shopper's search string for “cool keyboards” include a “Hard Rockin'/Honkey Tonkin'” electric piano 122, a Buster and His Bluesmen officially branded keyboard 123, and a Mac and Henry Fugue Generator keyboard 124. Each keyboard has recommendations, reviews, different prices, different numbers of keys, different features, and different capabilities. The “Hard Rockin'/Honkey Tonkin'” electric piano 122 has “klanky” barroom sounds with built in speakers and a microphone. The Buster and His Bluesmen officially branded keyboard 123 is designed for “blues bliss” and is hand-signed by Buster himself. The Mac and Henry Fugue Generator keyboard 124 promises to teach one to “play like Bach” in under five minutes and includes a compact disk and instruction booklet for the process.

Being a nefarious actor, with diabolical thoughts in mind, the shopper 120 also exclaims 125, “I'll return it tomorrow just like I do EVERY WEEK.” Since the shopper 120 has no plans whatsoever to ultimately pay, he immediately eyes the Buster and His Bluesmen officially branded keyboard 123 because he knows the wedding guests will be amazed at this magnificent piece of gear and will tip the shopper 120 even more money when they hear its gorgeous bluesy sounds. Still, the shopper 120 is clearly a textbook example of a dishonest customer exploiting a generous return policy to return a used item for a refund or exchange. As noted above, this results in financial losses for the poor keyboard vendor operating the electronic shopping interactive computing environment 127.

Advantageously, the system 100 of FIG. 1 is going to thwart this unsavory practice. Embodiments of the disclosure understand that the shopper 120 is well versed in contributing to the significant issue of fraudulent transactions in the e-commerce space, particularly focusing on fraudulent returns. Fraudsters such as the shopper 120 often exploit return policies by purchasing legitimate items and then returning fake or used items. Traditional methods to combat this, such as customer identity verification, restocking fees, and limiting return windows, are not entirely effective and can be costly to implement. Moreover, the fraudster knows he can attempt end runs around prior art practices by simply frequently resetting the computer, uninstalling and reinstalling applications, and changing SIM cards. These actions make tracking and preventing fraudulent activities difficult for merchants.

Advantageously, the system 100 of FIG. 1 involves tracking these suspicious behaviors by recording various device-level data parameters, including SIM card swaps 112, factory data resets 113, application data/cache clears 115, application logouts/logins 118, and application uninstalls/reinstalls 116. Additionally, the system records user account information 119 such as phone numbers, login identifiers, addresses, and payment information across these activities. By analyzing this data at step 101 and calculating a fraudulent return propensity score 128, the system 100 calculates a propensity score that quantifies the likelihood of the shopper 120 engaging in fraudulent returns. This fraudulent return propensity score 128 is used to take preventive measures, such as blocking new orders at step 107, restricting return capabilities at step 109, or even blocking access to the shopping application altogether at step 105.

The mechanics of the propensity score calculation at step 101 can vary. Initially, all tracked behaviors are given equal weight, allowing for immediate flagging of suspicious activities. However, as the system 100 learns from user behavior, the system 100 can adjust the weights to account for legitimate actions, such as factory resets due to device aging. In one or more embodiments, the system 100 operates continuously, monitoring user actions and adjusting the fraudulent return propensity score 128 based on feedback from return behaviors and seller feedback on the quality of returned products 117. This dynamic and proactive approach aims to mitigate the risk of fraudulent returns, thereby protecting retailers from financial losses and maintaining a fair shopping environment for honest customers.

Beginning at step 101, in response to the shopper's initiation of the interactive session 126 of the electronic shopping interactive computing environment 127, one or more processors of an electronic device, which could be the computer of step 103, a cloud server providing the electronic shopping interactive computing environment 127, or another electronic device, determine a fraudulent return propensity score 128. This can be done in a variety of ways.

In one or more embodiments, the system 100 comprises several interconnected modules designed to detect and prevent fraudulent product returns by leveraging device-level data. At step 101 a “Propensity Score Calculator” module can calculate a fraudulent return propensity score 128 for the shopper 120 based on data recorded by a “Data Recorder”module.

In one or more embodiments, the Data Recorder module captures various user actions, including SIM card swaps 112, factory data resets 113, the return history 114 associated with the shopper 120, application data/cache clears 115, application logouts/logins 118, and application uninstalls/reinstalls 116. In one or more embodiments, the Data Recorded module also records user account information 119 such as phone numbers, login identifiers, addresses, and payment information across these device-level activities.

In one or more embodiments, step 101 comprises weighting a plurality of input parameters to obtain a plurality of weighted input parameters and summing the plurality of weighted input factors to obtain a raw fraudulent return propensity score. In one or more embodiments, step 101 further normalizes the raw fraudulent return propensity score to obtain a normalized fraudulent return propensity score having a value between zero and one, inclusive.

Illustrating by example, in one or more embodiments the plurality of input parameters comprises one or more hardware reconfiguration events, examples of which include a number of subscriber identity module swaps 112 occurring at the electronic device, a number of factory data resets 113 occurring at the electronic device, and a number of cache clears 115 occurring in a memory of the electronic device. In one or more embodiments, plurality of input parameters further comprises a number of electronic shopping interactive computing environment reinstalls 116 occurring at the electronic device and a number of electronic shopping interactive computing environment log out and login events 118 occurring in the electronic shopping interactive computing environment 127.

In one or more embodiments, the plurality of input parameters further comprises at least one product return user interaction event in the return history 114 corresponding to at least one shopping cart interaction event occurring in the electronic shopping interactive computing environment 127. Other factors, such as the return condition 117 of products returned can be used as well.

At step 102, a “User Return Behavior Monitor” module tracks the shopper's present behavior in the electronic shopping interactive computing environment 127. In one or more embodiments, step 102 also monitors and tracks past return activities and the seller's feedback on the quality of returned products 117.

In one or more embodiments, this monitored information is used to adjust the weights assigned to different parameters in the fraudulent return propensity score 128 calculations. When normalized, the fraudulent return propensity score 128 ranges from zero to one, with one indicating a high likelihood of fraudulent behavior. In one or more embodiments, the system 100 employs a machine learning algorithm to dynamically weigh the input parameters and generate a normalized fraudulent return propensity score.

Based on the calculated propensity score, an “Action Executor” module determines the appropriate preventive measures via a plurality of decisions, shown in the system 100 of FIG. 1 as decision 104, decision 106, and decision 108. Illustrating by example, in one or more embodiments the Action Executor module precludes one or more user interaction events from occurring in the electronic shopping interactive computing environment 127 when the fraudulent return propensity score 128 exceeds a predefined threshold.

Advantageously, these measures may include blocking the user from making new orders, alerting the user that no return facility is available for new orders, or blocking the device from accessing the online shopping application altogether. This proactive approach aims to mitigate the risk of fraudulent returns, thereby protecting retailers from financial losses and maintaining the integrity of the e-commerce platform.

In one or more embodiments, when the fraudulent return propensity score 128 exceeds a first threshold above the predefined threshold, as determined by decision 104, the precluding the one or more user interaction events comprises precluding all user interaction events from occurring in the electronic shopping interactive computing environment 127 at step 105. In one or more embodiments, when the fraudulent return propensity score 128 exceeds a second threshold located between the predefined threshold and the first threshold, as determined at decision 106, but fails to exceed the first threshold, the precluding the one or more user interaction events comprises precluding a shopping cart interaction event from occurring in the electronic shopping interactive computing environment 127 at step 107. Effectively, this blocks the shopper's ability to place orders.

In one or more embodiments, when the fraudulent return propensity score exceeds a third threshold located between the predefined threshold and the second threshold, as determined by decision 108, but fails to exceed the second threshold, the precluding the one or more user interaction events comprises presenting a prompt on a user interface of the electronic device indicating that any shopping cart interaction events will be unavailable for product return user interaction events in the electronic shopping interactive computing environment 127 at step 109. While this may allow the shopper 120 to buy that fancy Buster and His Bluesmen officially branded keyboard 123, he will not be able to return it at a later date due to his nefarious past activity. Thus, in one or more embodiments step 109 precludes any product return user interaction events corresponding to shopping cart interaction events occurring after presentation of the prompt.

In this illustrative example, the shopper 120 is evaluating three keyboards: a “Hard Rockin'/Honkey Tonkin'” electric piano 122, a Buster and His Bluesmen officially branded keyboard 123, and a Mac and Henry Fugue Generator keyboard 124. As noted above, the shopper 120 intends to purchase the Buster and His Bluesmen officially branded keyboard 123 for a gig that night, with plans to return the Buster and His Bluesmen officially branded keyboard 123 used for a refund afterward. Where the fraudulent return propensity score 128 is below the predefined threshold, as indicated at step 110, there are no restrictions on returns at step 111.

Clearly our shopper 120 will not fall into this category. To wit, the return history 114 of the shopper 120 indicates that in the past six weeks the shopper 120 has exhibited an excessive return history involving ten different keyboards, each returned in poor condition after being used at rowdy gigs.

In the first week, the shopper 120 purchased a “Hard Rockin'/Honkey Tonkin'” electric piano 122, known for the “klanky” barroom sounds and built-in speakers and microphone. After using the electric piano 122 at a particularly boisterous event, the keyboard was returned with significant damage to the speakers and microphone.

The second week saw the purchase of a Chris Parks signature keyboard. This keyboard was returned with scratches and dents, indicating rough handling. The third week involved a Mac and Henry Fugue Generator keyboard 124. This keyboard was returned with broken components and a damaged instruction booklet.

In subsequent weeks, the shopper 120 continued this pattern with various other keyboards. A “Jazz Maestro” keyboard, known for smooth jazz tones, was returned with beer stains and a broken sustain pedal. A “Rock Legend” keyboard, featuring heavy metal sounds, came back with missing keys and a cracked casing.

A “Classical Virtuoso” keyboard, designed for classical music enthusiasts, was returned with water damage and a malfunctioning power supply. A “Synthwave Dream” keyboard, popular for retro sounds, was returned with a damaged display screen and non-functional buttons. A “Pop Star” keyboard, favored for modern pop sounds, was returned with a broken stand and torn power cord. A “Funk” keyboard, known for funky rhythms, was returned with damaged speakers and a non-responsive touchpad. An “Electronic Wizard” keyboard, designed for electronic music production, was returned with a corrupted memory and broken USB ports.

Each of these keyboards was returned with a poor return condition 117, reflecting the shopper's pattern of damaging the products during rowdy gigs and then seeking refunds. Accordingly, his fraudulent return propensity score 128 is nearly one, as detected at decision 104. Accordingly, his access to the electronic shopping interactive computing environment 127 is terminated at step 105. Advantageously, this preclusion from even using the electronic shopping interactive computing environment 127 provides robust fraud protection preventing such fraudulent returns and protecting retailers from financial losses.

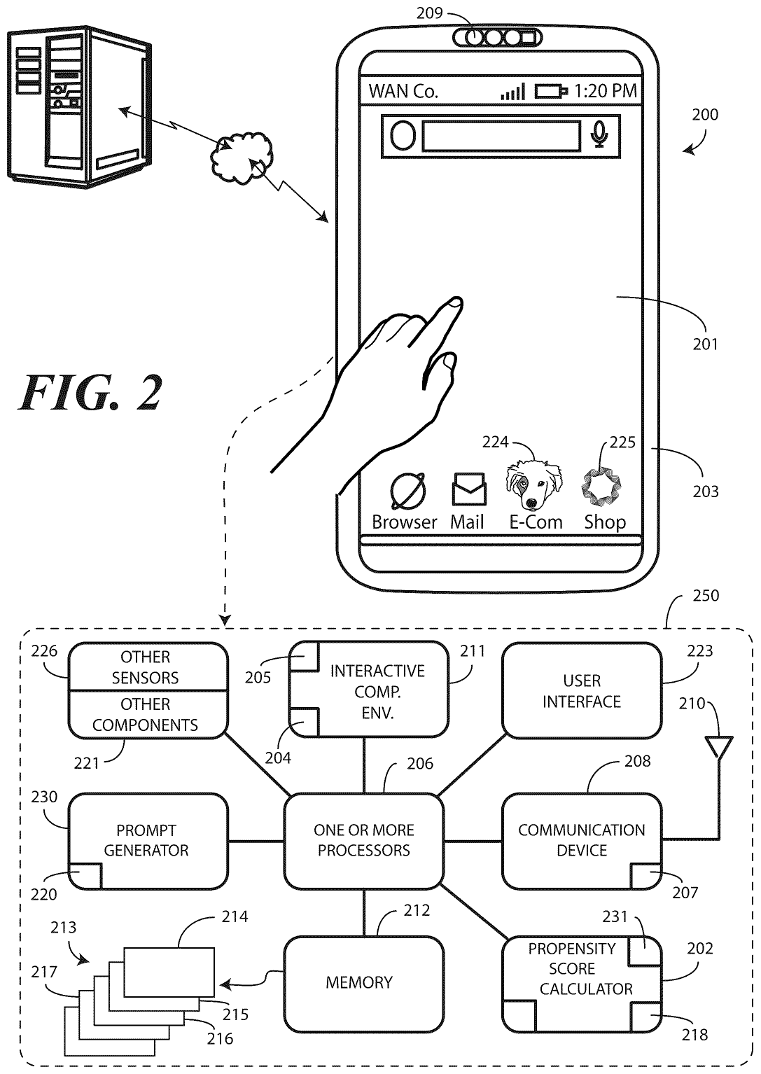

Turning now to FIG. 2, illustrated therein is one explanatory electronic device 200 configured in accordance with one or more embodiments of the disclosure. The electronic device 200 of this illustrative embodiment includes a user interface 223. In one or more embodiments, the user interface 223 comprises a display 201, which may optionally be touch-sensitive. The display 201 can serve as a primary user interface 223 of the electronic device 200.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 250 of the electronic device 200 is also shown in FIG. 2. In one embodiment, the electronic device 200 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 200. Each of the application processor and the auxiliary processor(s) can be configured to process and execute executable software code to perform the various functions of the electronic device 200. A storage device, such as memory 212, can optionally store the executable software code used by the one or more processors 206 during operation.

In this illustrative embodiment, the electronic device 200 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 200 can optionally include a near field communication circuit 207 used to exchange data, power, and electrical signals between the electronic device 200 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 200. For example, in one embodiment the one or more processors 206 comprise one or more circuits operable to present presentation information, such as images, text, and video, on the display 201. When an electronic shopping application 225 is actuated, the one or more processors 206 can present an electronic shopping interactive computing environment 205 to a user on the display 201, within which the user can enter an interactive session 204 and make user interaction events. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 200.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 200, an electronic mail application configured to send and receive electronic mail, a photo application configured to organize, manage, and present photographs on the display 201 of the electronic device 200, and a camera application for capturing images with the imager 209.

Collectively, these applications constitute an “application suite. ” In one or more embodiments, these applications comprise one or more e-commerce applications 224 and/or electronic shopping applications 225 that allow electronic commerce orders to be placed and financial transactions to be made using the electronic device 200.

Illustrating by example, in one or more embodiments a user can deliver user input to an e-commerce application 224 to launch an interactive session 204 of an electronic shopping interactive computing environment 211 that operates on the one or more processors 206. They can then deliver user input to the user interface 223 to define one or more search strings corresponding to one or more categories within the electronic shopping interactive computing environment 211. The one or more processors 206 can then monitor user interaction events in the electronic shopping interactive computing environment 211 to determine a fraudulent return propensity score 231 as previously described.

In one or more embodiments, in response to the one or more processors 206 detecting commencement of an interactive session 204 of an electronic shopping application 225 operating on the one or more processors 206, the one or more processors 206, using a propensity score calculator 202, can determine a fraudulent return propensity score 231. In one or more embodiments, the propensity score calculator 202 stores one or more fraudulent return propensity score thresholds 218. In one or more embodiments, when the fraudulent return propensity score 231 exceeds a predefined threshold of the one or more fraudulent return propensity score predefined thresholds 218, the one or more processors 206 preclude one or both of shopping cart user interaction events and/or product return user interaction events from occurring in the electronic shopping application 225.

In one or more embodiments, when the fraudulent return propensity score 231 exceeds another predefined threshold of the one or more fraudulent return propensity score predefined thresholds 218 located above the predefined threshold, the one or more processors 206 terminate the interactive shopping session. In one or more embodiments, when the fraudulent return propensity score 231 exceeds another predefined threshold of the one or more fraudulent return propensity score predefined thresholds 218 located above the predefined threshold the one or more processors 206 block both the shopping cart user interaction events and the product return user interaction events from occurring in the electronic shopping application 225. In one or more embodiments, when the fraudulent return propensity score 231 falls between the predefined threshold and the another predefined threshold the one or more processors 206 block only the product return user interaction events from occurring in the electronic shopping application 225.

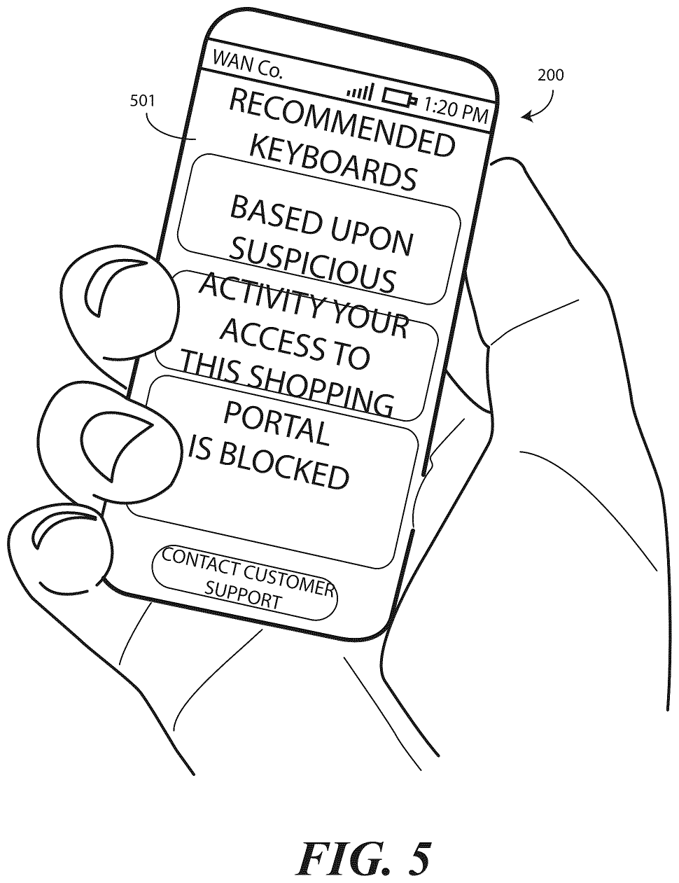

In one or more embodiments, the one or more processors 206 further cause the user interface 223 to present a prompt 220 identifying which of the one or both of the shopping cart user interaction events and/or the product return user interaction events is precluded from occurring in the electronic shopping application 225. In one or more embodiments, a prompt generator 230 generates this prompt. Turning briefly to FIGS. 5-7, illustrated therein are examples of such a prompt.

Beginning with FIG. 5, illustrated therein is the electronic device 200 displaying a first prompt 501. In one or more embodiments, this prompt 501 appears when the fraudulent return propensity score (231) exceeds another predefined threshold located above the predefined threshold where the one or more processors (206) preclude one or both of shopping cart user interaction events and/or product return user interaction events from occurring in the electronic shopping application (225). Consequently, the one or more processors terminate the interactive shopping session after presenting the prompt 501.

The prompt 501 displayed on the electronic device 200 informs the user that access to the shopping portal is blocked due to suspicious activity. The message reads: “RECOMMENDED KEYBOARDS BASED UPON SUSPICIOUS ACTIVITY YOUR ACCESS TO THIS SHOPPING PORTAL IS BLOCKED.” This notification indicates that the system has detected behavior indicative of potential fraud and has taken preventive measures to restrict the user's access to the shopping application.

After presenting the prompt 501, the system may offer the user an option to contact customer support for further assistance. This action allows the user to address any issues or disputes regarding the blocked access. The prompt 501 includes a “CONTACT CUSTOMER SUPPORT” user actuation target, which the user can select to initiate communication with customer support representatives. This feature ensures that legitimate users who may have been incorrectly flagged can resolve the issue and regain access to the shopping application.

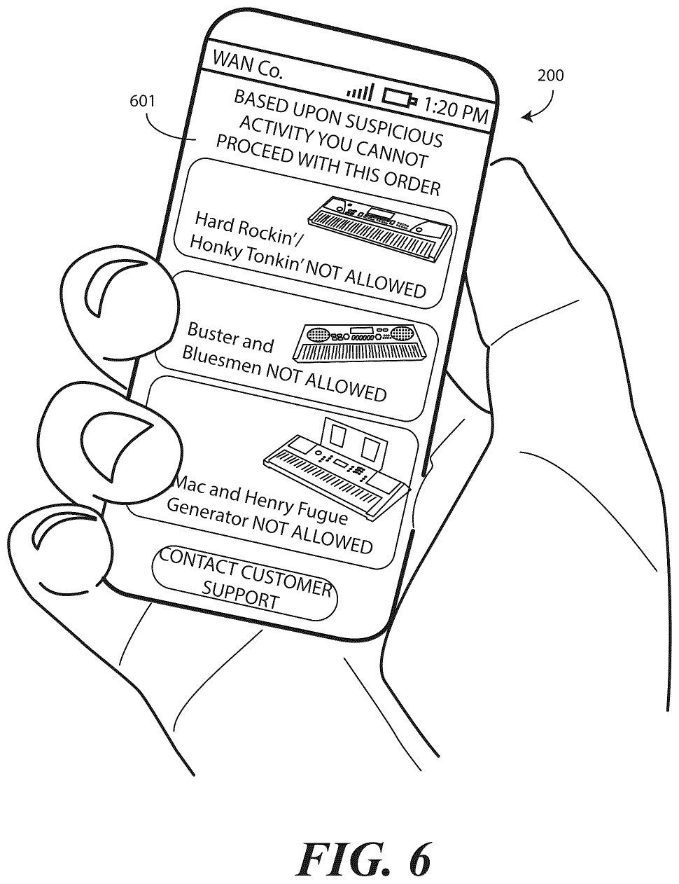

Turning now to FIG. 6, illustrated therein is the electronic device 200 displaying another prompt 601. The prompt 601 appears when the fraudulent return propensity score (231) exceeds another predefined threshold located above the predefined threshold where the one or more processors (206) preclude one or both of shopping cart user interaction events and/or product return user interaction events from occurring in the electronic shopping application (225). As a result, the one or more processors (206) block both the shopping cart user interaction events and the product return user interaction events from occurring in the electronic shopping application (225).

In this illustrative embodiment, the prompt 601 informs the user that, based on suspicious activity detected on the device, the user cannot proceed with the order. The message displayed on the electronic device 200 reads: “BASED UPON SUSPICIOUS ACTIVITY YOU CANNOT PROCEED WITH THIS ORDER.” This notification indicates that the system has detected behavior indicative of potential fraud and has taken preventive measures to restrict the user's ability to place orders.

The electronic device 200 still allows interaction with the electronic shopping application (225), as indicated by the fact that the user interface (223) still shows a list of products, including “Hard Rockin'/Honky Tonkin',” “Buster and Bluesmen,” and “Mac and Henry Fugue Generator.” However, each is accompanied by a “NOT ALLOWED” banner. These banners indicate that shopping cart user interaction events are prohibited for these products, preventing the user from adding them to the shopping cart or proceeding with the purchase.

A “CONTACT CUSTOMER SUPPORT” user actuation target is also displayed on the electronic device 200. This target allows the user to contact customer support if the user believes the prompt 601 is shown in error. This feature ensures that legitimate users who may have been incorrectly flagged can resolve the issue and regain access to the shopping application.

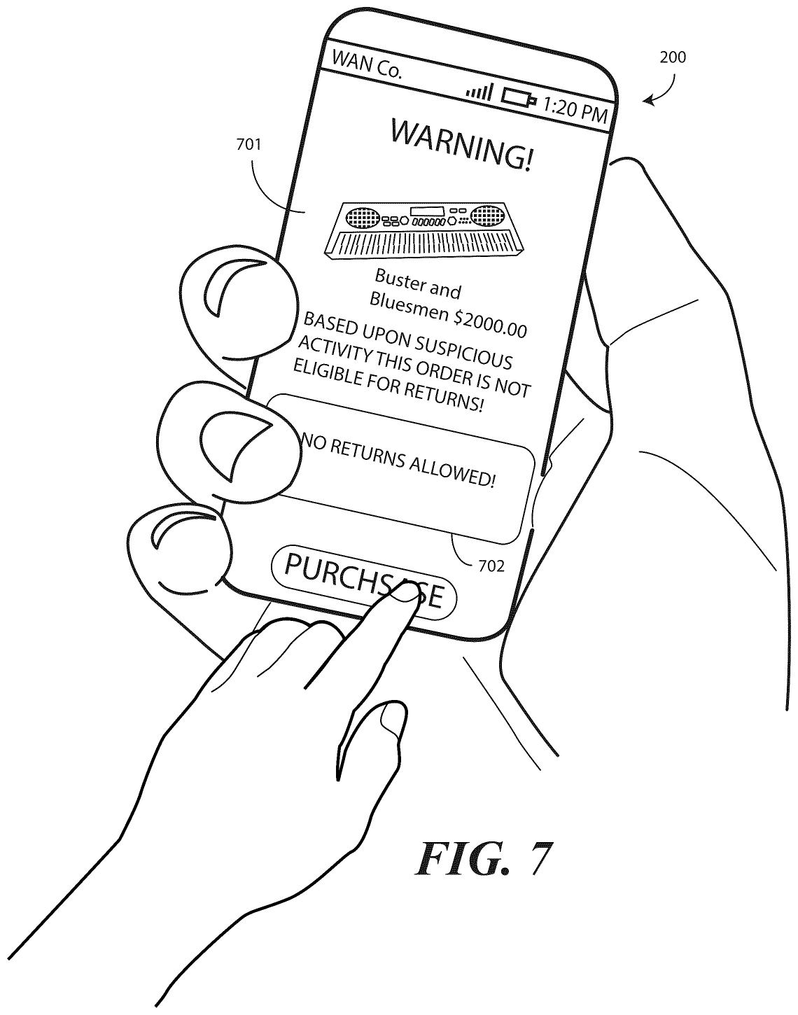

Turning now to FIG. 7, illustrated therein is the electronic device 200 presenting still another prompt 701 because the fraudulent return propensity score (231) exceeds a predefined threshold where the one or more processors (206) preclude product return user interaction events from occurring in the electronic shopping application (225). In this illustrative embodiment, the electronic device 200 displays a warning message indicating that the order is not eligible for returns due to suspicious activity detected on the device.

The prompt 701 prominently displays the product information for the Buster and His Bluesmen keyboard, including the price of $2000.00. The warning message reads: “BASED UPON SUSPICIOUS ACTIVITY THIS ORDER IS NOT ELIGIBLE FOR RETURNS!” This notification informs the user that, due to their high fraudulent return propensity score (231), they will not be able to return the keyboard if they decide to purchase the keyboard.

A sub-prompt 702 is also displayed, indicating “NO RETURNS ALLOWED!” This sub-prompt 702 reinforces the restriction on returns for the specified product. Despite the restriction, the user can still proceed with the purchase by selecting the “PURCHASE” button displayed on the screen.

The electronic device 200 ensures that users identified as high-risk for fraudulent returns are restricted from performing return actions, thereby protecting retailers from potential financial losses. The system leverages device-level data to calculate the fraudulent return propensity score, enhancing the accuracy of fraud detection and maintaining the integrity of the e-commerce platform.

It should be noted that the prompts 501,601,701 of FIGS. 5-7 are illustrative only. Others suitable for presentation when the fraudulent return propensity score (231) exceeds one or more thresholds will be obvious to those of ordinary skill in the art having the benefit of this disclosure.

Turning now back to FIG. 2, in one or more embodiments the one or more processors 206 are responsible for managing the applications and all personal information received from the user interface 223 that is to be used by the e-commerce application 224 and/or electronic shopping application 225 after the electronic device 200 is authenticated as a secure electronic device and the user identification credentials have triggered an electronic payment transaction request to complete an electronic shopping cart interaction event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 200 is reported stolen or when the e-commerce application 224 and/or electronic shopping application 225 are used with fraudulent activity to wipe the memory 212 clean of any personal data, preferences, or settings of the person previously using the electronic device 200.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 200 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 200.

In one or more embodiments, the electronic device 200 comprises a prompt generator 230 as well. In one or more embodiments, the prompt generator generates a prompt 220 identifying whether the one or both of shopping cart user interaction events and/or product return user interaction events will be precluded from occurring in the electronic shopping interactive computing environment 205. In one or more embodiments, the prompt 220 is presented by the one or more processors 206 on the user interface 223 in response to the normalized fraudulent return propensity score 231 exceeding a predefined threshold.

In one or more embodiments, the prompt 220 is presented only when the one or more processors 206 detect at least one product return user interaction event corresponding to shopping cart interaction events occurring in the electronic shopping interactive computing environment 205 within a predefined prior duration occurring before commencement of the electronic shopping interactive computing environment 205. Thus, our shopper (120) from FIG. 1 would see the prompt due to the fact that he had returned ten keyboards in only six weeks.

In one or more embodiments, the propensity score calculator 202 and the prompt generator 230 can be operable with one or more processors 206, configured as a component of the one or more processors 206, or configured as one or more executable code modules operating on the one or more processors 206. In other embodiments, the propensity score calculator 202 and the prompt generator 230 can be standalone hardware components operating executable code or firmware to perform their functions. Other configurations for the propensity score calculator 202 and the prompt generator 230 will be obvious to those of ordinary skill in the art having the benefit of this disclosure.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

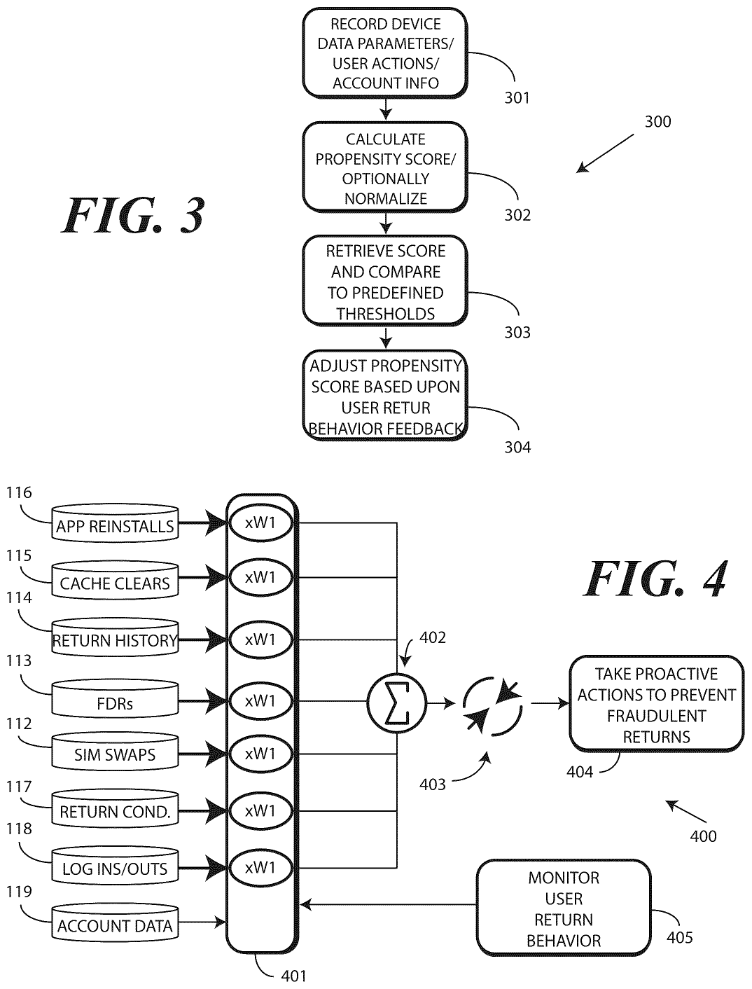

Turning now to FIG. 3, illustrated therein is one explanatory method 300 in accordance with one or more embodiments of the disclosure. Step 301 of the method 300 of FIG. 3 involves monitoring, by one or more processors of the electronic device, a plurality of input parameters. The one or more processors continuously track various device-level activities to gather comprehensive data on user behavior. These input parameters can include SIM card swaps, factory data resets, application data/cache clears, application logouts/logins, and application uninstalls/reinstalls. By monitoring these parameters, the system can detect patterns indicative of fraudulent behavior. The one or more processors analyze this data to identify suspicious activities that may suggest a high likelihood of fraudulent returns.

Step 302 of the method 300 of FIG. 3 involves determining, by the one or more processors, a normalized fraudulent return propensity score from the plurality of input parameters. In one or more embodiments, the one or more processors weight the various input parameters to obtain a plurality of weighted input parameters. These weighted input parameters are then summed to obtain a raw fraudulent return propensity score. In one or more embodiments, the one or more processors normalize this raw score to obtain a normalized fraudulent return propensity score, which ranges from zero to one, with one indicating a high likelihood of fraud. This score quantifies the risk of fraudulent behavior based on the monitored device-level activities.

Step 303 of the method 300 of FIG. 3 involves retrieving, by the one or more processors from a memory, the normalized fraudulent return propensity score in response to initiation of an interactive session of an electronic shopping interactive computing environment operating on the one or more processors of the electronic device. When a user initiates an interactive session in the electronic shopping application, the one or more processors retrieve the previously calculated normalized fraudulent return propensity score from the memory. This retrieval allows the system to assess the risk of fraudulent behavior in real-time as the user engages with the shopping application. If the normalized fraudulent return propensity score exceeds a predefined threshold, the one or more processors take preventive measures to preclude one or more user interaction events from occurring in the electronic shopping interactive computing environment.

Step 304 of the method 300 of FIG. 3 involves adjusting, by the one or more processors, the normalized fraudulent return propensity score in response to product return condition feedback data received by a communication device from a remote electronic device. In one or more embodiments, the system continuously monitors the condition of returned products and receives feedback from sellers regarding the quality and state of the returned items. This feedback data is transmitted to the electronic device via a communication device, which may include wireless communication technologies such as Wi-Fi, Bluetooth, or cellular networks.

Upon receiving the product return condition feedback data, the one or more processors analyze the information to determine if the returned items exhibit signs of fraudulent behavior, such as damage, wear, or discrepancies between the returned item and the original product. The system then adjusts the normalized fraudulent return propensity score at step 304 based on this analysis, increasing the score if the feedback indicates potential fraud or decreasing the score if the feedback suggests legitimate returns.

This dynamic adjustment of the propensity score ensures that the system remains accurate and responsive to real-time data, enhancing the system's ability to detect and prevent fraudulent returns. By incorporating seller feedback into the propensity score calculation, the system can more effectively identify patterns of fraudulent behavior and take appropriate preventive measures, such as blocking new orders or restricting return capabilities, thereby protecting retailers from financial losses and maintaining the integrity of the e-commerce platform.

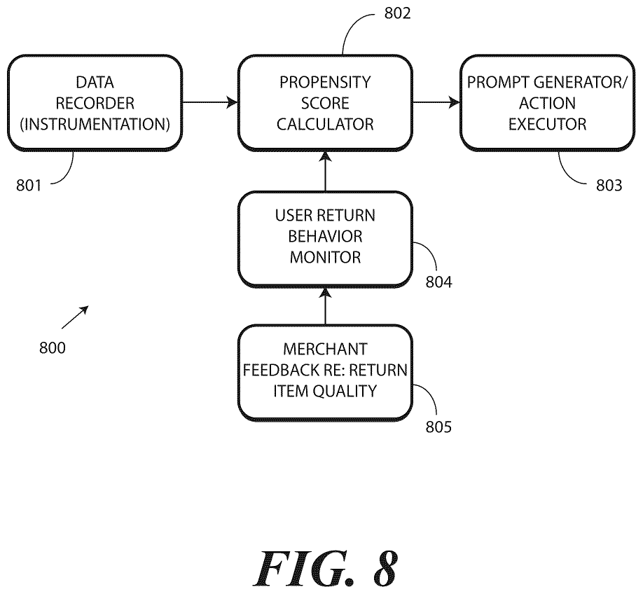

Turning now to FIG. 4, illustrated therein is one explanatory system 400 in accordance with one or more embodiments of the disclosure. Prior to considering the functions shown in FIG. 4, the constituent parts of the system are shown in FIG. 8.

Turning briefly to FIG. 8, illustrated therein is a system block diagram 800 comprising several interconnected components designed to detect and prevent fraudulent product returns by leveraging device-level data. The primary components include the Data Recorder 801, the Propensity Score Calculator 802, the Prompt Generator/Action Executor 803, the User Return Behavior Monitor 804, and the Merchant Feedback Monitor 805.

The Data Recorder 801 captures various user actions and device-level activities that are indicative of potential fraudulent behavior. These activities include SIM card swaps, factory data resets, application data/cache clears, application logouts/logins, and application uninstalls/reinstalls. The Data Recorder 801 also records user account information such as phone numbers, login identifiers, addresses, and payment information across these device-level activities. By tracking these parameters, the Data Recorder 801 provides a comprehensive dataset that can be analyzed to detect patterns of suspicious behavior.

The Propensity Score Calculator 802 utilizes the data recorded by the Data Recorder 801 to calculate a fraudulent return propensity score for the user. This score quantifies the likelihood of the user engaging in fraudulent returns. The Propensity Score Calculator 802 employs a machine learning algorithm to weigh the various parameters and generate a normalized propensity score ranging from zero to one, where one indicates a high likelihood of fraud. The machine learning algorithm dynamically adjusts the weights assigned to different parameters based on feedback from user return behavior and seller feedback on the quality of returned products.

The Prompt Generator/Action Executor 803 takes preventive measures based on the calculated propensity score. When the propensity score exceeds a predefined threshold, the Prompt Generator/Action Executor 803 precludes one or more user interaction events from occurring in the electronic shopping interactive computing environment. These preventive measures may include blocking the user from making new orders, alerting the user that no return facility is available for new orders, or blocking the device from accessing the online shopping application altogether. The Prompt Generator/Action Executor 803 ensures that users identified as high-risk are restricted from performing actions that could lead to fraudulent returns, thereby protecting retailers from financial losses.

The User Return Behavior Monitor 804 tracks the user's return behavior over time. This component monitors the number of returns, the type of products being returned, the time between order delivery and product return, and the seller's feedback on the quality of returned products. The User Return Behavior Monitor 804 provides insights into the user's return patterns, which are used to adjust the weights assigned to different parameters in the propensity score calculation. This continuous monitoring ensures that the system remains accurate and responsive to real-time data, enhancing the system's ability to detect and prevent fraudulent returns.

The Merchant Feedback Monitor 805 collects feedback from sellers regarding the condition and quality of returned products. This feedback is transmitted to the system and analyzed to determine if the returned items exhibit signs of fraudulent behavior, such as damage, wear, or discrepancies between the returned item and the original product. The Merchant Feedback Monitor 805 plays a role in refining the propensity score calculation by providing real-time data on the quality of returned products. This feedback loop allows the system to dynamically adjust the propensity score based on the condition of returned items, further enhancing the accuracy of fraud detection.

Turning now back to FIG. 4, in one or more embodiments the Propensity Score Calculator (802) calculates a fraudulent return propensity score for the user based on data recorded by the Data Recorder (801). The Data Recorder (801) captures various user actions, including SIM card swaps 112, factory data resets 113, application data/cache clears 115, application logouts/logins 118, and application uninstalls/reinstalls 116. The Data Recorder (801) also records user account information 119 such as phone numbers, login identifiers, addresses, and payment information across these device-level activities.

The User Return Behavior Monitor 804 tracks the user's return behavior 405 over time. This module monitors the number of returns, the type of products being returned, the time between order delivery and product return, and the seller's feedback on the quality of returned products 117. This monitored information is used to adjust the weights 401 assigned to different parameters in the fraudulent return propensity score calculation. When these parameters are summed 402 and normalized 403, the fraudulent return propensity score ranges from zero to one, with one indicating a high likelihood of fraudulent behavior. The system employs a machine learning algorithm to dynamically weigh the input parameters and generate a normalized fraudulent return propensity score.

Based on the calculated propensity score, the Action Executor 803 determines the appropriate preventive measures 404. These measures 404 may include blocking the user from making new orders, alerting the user that no return facility is available for new orders, or blocking the device from accessing the online shopping application altogether. This proactive approach aims to mitigate the risk of fraudulent returns, thereby protecting retailers from financial losses and maintaining the integrity of the e-commerce platform.

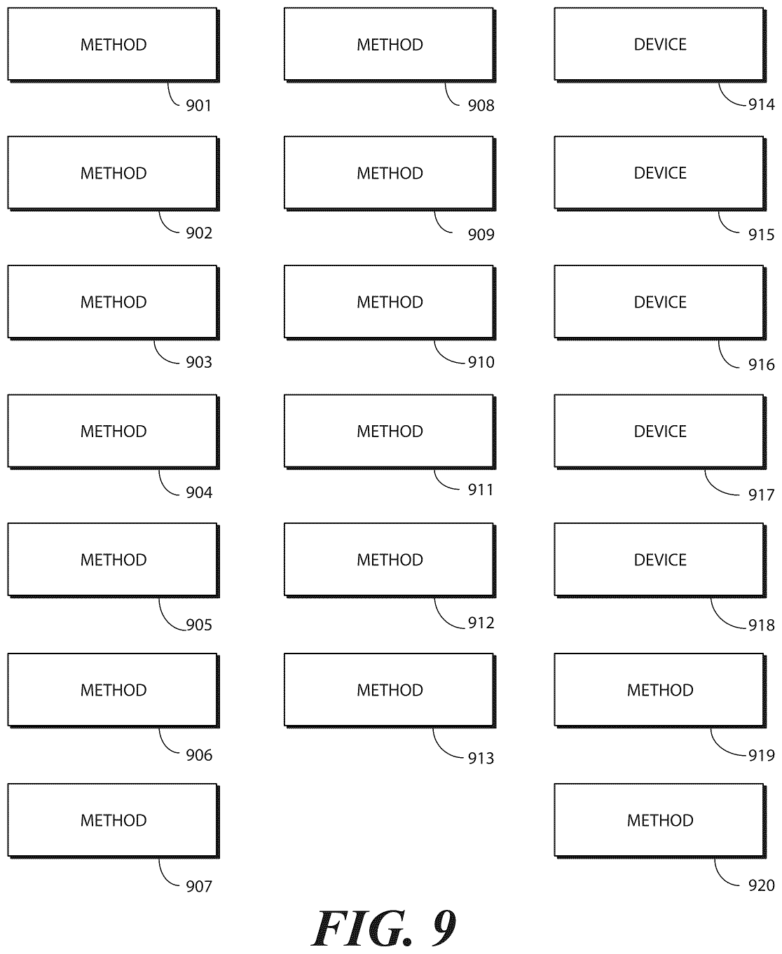

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8 which precede FIG. 9. Accordingly, since these items have previously been illustrated and described, their repeated illustration is no longer essential for a proper understanding of these embodiments. Thus, the embodiments are shown as labeled boxes.

At 901, a method for an electronic device comprises, in response to initiation of an interactive session in an electronic shopping interactive computing environment operating on one or more processors of the electronic device, determining, by the one or more processors, a fraudulent return propensity score. At 901, when the fraudulent return propensity score exceeds a predefined threshold, the method comprises precluding one or more user interaction events from occurring in the electronic shopping interactive computing environment.

At 902, when the fraudulent return propensity score exceeds a first threshold above the predefined threshold, the precluding the one or more user interaction events of 901 comprises precluding all user interaction events from occurring in the electronic shopping interactive computing environment.

At 903, when the fraudulent return propensity score exceeds a second threshold located between the predefined threshold and the first threshold, but fails to exceed the first threshold, the precluding the one or more user interaction events of 902 comprises precluding a shopping cart interaction event from occurring in the electronic shopping interactive computing environment.

At 904, when the fraudulent return propensity score exceeds a third threshold located between the predefined threshold and the second threshold, but fails to exceed the second threshold, the precluding the one or more user interaction events of 903 comprises presenting a prompt on a user interface of the electronic device indicating that any shopping cart interaction events will be unavailable for product return user interaction events in the electronic shopping interactive computing environment. At 905, the method of 904 further comprises precluding, by the one or more processors, any product return user interaction events corresponding to shopping cart interaction events occurring after presentation of the prompt.

At 906, the determining the fraudulent return propensity score of 901 comprises, by the one or more processors, weighting a plurality of input parameters to obtain a plurality of weighted input parameters and summing the plurality of weighted input factors to obtain a raw fraudulent return propensity score. At 907, the plurality of input parameters of 906 comprises one or more hardware reconfiguration events occurring at the electronic device.

At 908, the one or more hardware reconfiguration events of 907 comprises a number of subscriber identity module swaps occurring at the electronic device, a number of factory default resets occurring at the electronic device, and a number of cache clears occurring in a memory of the electronic device. At 909, the plurality of input parameters of 908 further comprises a number of electronic shopping interactive computing environment reinstalls occurring at the electronic device and a number of electronic shopping interactive computing environment log out and login events occurring in the electronic shopping interactive computing environment.

At 910, the plurality of input parameters of 909 further comprises at least one product return user interaction event corresponding to at least one shopping cart interaction event occurring in the electronic shopping interactive computing environment. At 911, the method of 906 further comprises, by the one or more processors, normalizing the raw fraudulent return propensity score to obtain a normalized fraudulent return propensity score having a value between zero and one, inclusive.

At 912, an electronic device comprises a user interface, a memory, and one or more processors operable with the user interface and the memory. At 912, in response to the one or more processors detecting commencement of an interactive shopping session in an electronic shopping application operating on the one or more processors, the one or more processors determine a fraudulent return propensity score. At 912, when the fraudulent return propensity score exceeds a predefined threshold, the one or more processors preclude one or both of shopping cart user interaction events and/or product return user interaction events from occurring in the electronic shopping application.

At 913, when the fraudulent return propensity score of 912 exceeds another predefined threshold located above the predefined threshold the one or more processors terminate the interactive shopping session. At 914, when the fraudulent return propensity score of 912 exceeds another predefined threshold located above the predefined threshold the one or more processors block both the shopping cart user interaction events and the product return user interaction events from occurring in the electronic shopping application.

At 915, when the fraudulent return propensity score of 914 falls between the predefined threshold and the another predefined threshold the one or more processors block only the product return user interaction events from occurring in the electronic shopping application. At 916, the one or more processors of 015 further cause the user interface to present a prompt identifying which of the one or both of the shopping cart user interaction events and/or the product return user interaction events is precluded from occurring in the electronic shopping application.

At 917, a method for an electronic device comprises monitoring, by one or more processors of the electronic device, a plurality of input parameters. At 917, the method comprises determining, by the one or more processors, a normalized fraudulent return propensity score from the plurality of input parameters.

At 917, the method comprises retrieving, by the one or more processors from a memory, the normalized fraudulent return propensity score in response to initiation of an interactive session of an electronic shopping interactive computing environment operating on the one or more processors of the electronic device. At 917, the method comprises presenting, by the one or more processors on a user interface in response to the normalized fraudulent return propensity score exceeding a predefined threshold, a prompt.

At 918, the prompt of 917 identifies whether the one or both of shopping cart user interaction events and/or product return user interaction events will be precluded from occurring in the electronic shopping interactive computing environment. At 919, the prompt of 918 is presented only when the one or more processors detect at least one product return user interaction event corresponding to shopping cart interaction events occurring in the electronic shopping interactive computing environment within a predefined prior duration occurring before commencement of the electronic shopping interactive computing environment. At 920, the method of 919 further comprises adjusting, by the one or more processors, the normalized fraudulent return propensity score in response to product return condition feedback data received by a communication device from a remote electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device monitors a plurality of input parameters, including SIM card swaps, factory data resets, application data/cache clears, application logouts/logins, and application uninstalls/reinstalls. The system determines a normalized fraudulent return propensity score from these parameters, which quantifies the likelihood of fraudulent returns. Upon initiation of an interactive session in an electronic shopping environment, the system retrieves this score and, if the score exceeds a predefined threshold, presents a prompt on the user interface. This prompt may inform the user of restrictions on their ability to perform certain actions, such as making new orders or returning products.

In another embodiment, the system adjusts the propensity score based on feedback from product return conditions, such as the quality of returned items as reported by sellers. This feedback loop allows the system to refine the fraud detection accuracy over time. Additionally, the system may employ machine learning algorithms to dynamically weigh the input parameters, enhancing the ability to detect fraudulent behavior patterns.

In yet another embodiment, the system could integrate with third-party fraud prevention services to cross-reference user behavior data, further improving the fraud detection capabilities. The prompt presented to the user can vary in form, ranging from a simple notification to a detailed explanation of the restrictions imposed, depending on the severity of the detected fraudulent behavior. This adaptability ensures that the system can effectively mitigate the risk of fraudulent returns while maintaining a fair shopping environment for all users.

In one embodiment, the electronic device comprises a user interface, a memory, and one or more processors operable with the user interface and the memory. Upon detecting the commencement of an interactive shopping session in an electronic shopping application, the processors determine a fraudulent return propensity score. If this score exceeds a predefined threshold, the processors preclude one or both of shopping cart user interaction events and product return user interaction events from occurring in the application.

In another embodiment, the system may include additional sensors or modules to enhance data collection, such as accelerometers to detect device movement patterns or GPS modules to track location changes, which can be factored into the propensity score. In yet another embodiment, the system could integrate with external databases to cross-reference user behavior with known fraud patterns, thereby refining the propensity score calculation.

Additionally, the user interface may present various types of prompts or alerts based on the propensity score, ranging from simple notifications to more complex interactive dialogues that require user verification or additional authentication steps. The memory could store historical data on user interactions, allowing the system to adapt and learn over time, improving the accuracy in detecting fraudulent behavior.

Furthermore, the processors might employ advanced machine learning algorithms to continuously update the weighting of different input parameters, ensuring that the propensity score remains accurate and reflective of fraud trends. These embodiments demonstrate the system's adaptability and robustness in various operational contexts, enhancing the effectiveness in preventing fraudulent returns.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for an electronic device, the method comprising:
in response to initiation of an interactive session in an electronic shopping interactive computing environment operating on one or more processors of the electronic device, determining, by the one or more processors, a fraudulent return propensity score; and
when the fraudulent return propensity score exceeds a predefined threshold, precluding one or more user interaction events from occurring in the electronic shopping interactive computing environment.

2. The method of claim 1, wherein when the fraudulent return propensity score exceeds a first threshold above the predefined threshold, the precluding the one or more user interaction events comprises precluding all user interaction events from occurring in the electronic shopping interactive computing environment.

3. The method of claim 2, wherein when the fraudulent return propensity score exceeds a second threshold located between the predefined threshold and the first threshold, but fails to exceed the first threshold, the precluding the one or more user interaction events comprises precluding a shopping cart interaction event from occurring in the electronic shopping interactive computing environment.

4. The method of claim 3, wherein when the fraudulent return propensity score exceeds a third threshold located between the predefined threshold and the second threshold, but fails to exceed the second threshold, the precluding the one or more user interaction events comprises presenting a prompt on a user interface of the electronic device indicating that any shopping cart interaction events will be unavailable for product return user interaction events in the electronic shopping interactive computing environment.

5. The method of claim 4, further comprising precluding, by the one or more processors, any product return user interaction events corresponding to shopping cart interaction events occurring after presentation of the prompt.

6. The method of claim 1, wherein the determining the fraudulent return propensity score comprises, by the one or more processors, weighting a plurality of input parameters to obtain a plurality of weighted input parameters and summing the plurality of weighted input factors to obtain a raw fraudulent return propensity score.

7. The method of claim 6, wherein the plurality of input parameters comprises one or more hardware reconfiguration events occurring at the electronic device.

8. The method of claim 7, wherein the one or more hardware reconfiguration events comprises a number of subscriber identity module swaps occurring at the electronic device, a number of factory default resets occurring at the electronic device, and a number of cache clears occurring in a memory of the electronic device.

9. The method of claim 8, wherein the plurality of input parameters further comprises a number of electronic shopping interactive computing environment reinstalls occurring at the electronic device and a number of electronic shopping interactive computing environment log out and login events occurring in the electronic shopping interactive computing environment.

10. The method of claim 9, wherein the plurality of input parameters further comprises at least one product return user interaction event corresponding to at least one shopping cart interaction event occurring in the electronic shopping interactive computing environment.

11. The method of claim 6, further comprising, by the one or more processors, normalizing the raw fraudulent return propensity score to obtain a normalized fraudulent return propensity score having a value between zero and one, inclusive.

12. An electronic device, comprising:
a user interface;
a memory; and
one or more processors operable with the user interface and the memory;
wherein:
in response to the one or more processors detecting commencement of an interactive shopping session in an electronic shopping application operating on the one or more processors, the one or more processors determine a fraudulent return propensity score; and
when the fraudulent return propensity score exceeds a predefined threshold, the one or more processors preclude one or both of shopping cart user interaction events and/or product return user interaction events from occurring in the electronic shopping application.

13. The electronic device of claim 12, wherein when the fraudulent return propensity score exceeds another predefined threshold located above the predefined threshold the one or more processors terminate the interactive shopping session.

14. The electronic device of claim 12, wherein when the fraudulent return propensity score exceeds another predefined threshold located above the predefined threshold the one or more processors block both the shopping cart user interaction events and the product return user interaction events from occurring in the electronic shopping application.

15. The electronic device of claim 14, wherein when the fraudulent return propensity score falls between the predefined threshold and the another predefined threshold the one or more processors block only the product return user interaction events from occurring in the electronic shopping application.

16. The electronic device of claim 15, wherein the one or more processors further cause the user interface to present a prompt identifying which of the one or both of the shopping cart user interaction events and/or the product return user interaction events is precluded from occurring in the electronic shopping application.

17. A method for an electronic device, the method comprising:
monitoring, by one or more processors of the electronic device, a plurality of input parameters;
determining, by the one or more processors, a normalized fraudulent return propensity score from the plurality of input parameters;
retrieving, by the one or more processors from a memory, the normalized fraudulent return propensity score in response to initiation of an interactive session of an electronic shopping interactive computing environment operating on the one or more processors of the electronic device; and
presenting, by the one or more processors on a user interface in response to the normalized fraudulent return propensity score exceeding a predefined threshold, a prompt.

18. The method of claim 17, wherein the prompt identifies whether the one or both of shopping cart user interaction events and/or product return user interaction events will be precluded from occurring in the electronic shopping interactive computing environment.

19. The method of claim 18, wherein the prompt is presented only when the one or more processors detect at least one product return user interaction event corresponding to shopping cart interaction events occurring in the electronic shopping interactive computing environment within a predefined prior duration occurring before commencement of the electronic shopping interactive computing environment.

20. The method of claim 19, further comprising adjusting, by the one or more processors, the normalized fraudulent return propensity score in response to product return condition feedback data received by a communication device from a remote electronic device.
